(19) United States
(12) Patent Application Publication
(10) Pub. No.: US 2023/0266239 A1
(43) Pub. Date: Aug. 24, 2023

(54) Image Processing in Foggy Environments

(71) Applicant: Bevilacqua Research Corporation, Inc, Huntsville, AL (US)

(72) Inventor: Robert Pilgrim, Benton, KY (US)

(73) Assignee: Bevilacqua Research Corporation, Inc, Huntsville, AL (US)

(21) Appl. No.: 17/676,042

(22) Filed: Feb. 18, 2022

(51) Int. Cl. G01N 21/3554; G06T 5/00

(52) U.S. Cl. CPC G01N 21/3554; G06T 5/002

(57) ABSTRACT

A system and method for exploiting spectral absorption properties of water is disclosed. The system and method use spectral absorption properties of water to improve Short Wave InfraRed (SWIR) sensor (camera) performance in the presence of clouds. This is achieved partly by limiting the spectral passband of a sensor to a water absorption band, thereby improving Signal to Noise Ratio (SNR). Higher SNR permits improved CSO resolution. Further, higher SNR reduces the uncertainty in matching observations in one sensor to the epipolar lines of another sensor thus reducing the time needed to achieve unambiguous matches.

### BACKGROUND OF THE INVENTION

One reason that fog is difficult to see through is that light does penetrate in, but the various water droplets act as a type of lens and scatter the light so that the fogged items don't make visual sense, and they are unrecognizable. This means the light is not useful for illuminating shapes and outlines, and instead doesn't illuminate anything.

An example earlier mechanism that attempts to resolve this issue using a water-absorption band of 940 nm is disclosed in U.S. Pat. No. 9,077,868, issued Jul. 7, 2015. That earlier mechanism was limited by the fact that the water absorption band is only about 10 nm wide and that VIS/NIR (visible/nearInfraRed) detector sensitivity is very low in the NIR spectrum. Consequently, an improved mechanism for overcoming problems such as scattering effect, and other problems, is desired.

### SUMMARY OF THE INVENTION

The spectral absorption properties of water can be exploited to improve SWIR sensor performance in the presence of clouds. Limiting the spectral passband of a sensor to a water absorption band can improve SNR (Signal to Noise Ratio). Higher SNR permits improved CSO resolution. Further, higher SNR reduces the uncertainty in matching observations in one sensor to the epipolar lines of another sensor, thus reducing the time needed to achieve unambiguous matches.

### BRIEF DESCRIPTION OF THE DRAWINGS

FIG. 1A shows a spectrograph of water absorption in the Near InfraRed/Short Wave InfraRed (NIR/SWIR) regions;

FIG. 1B shows a system having a filter housed within a frame/chassis of an SWIR sensor (camera);

FIG. 2 shows changes in atmospheric transmittance according to variations in wavelength;

FIGS. 3A and 3B show a method by which scattered light is reduced in the water absorption band;

FIG. 4 shows a standard visible view (left) compared with a view (right) provided by an earlier version of the system at 940 nm;

FIG. 5 shows empirical cloud modeling using U.S. Army Ground-Based Measurements (GBM) sensor in the LWIR and SWIR passbands;

FIG. 6 shows an example of autoregressive moving average modeling a framework;

FIG. 7 shows a visual application of the framework of FIG. 6 to a particular cloud, in which alpha (α) is varied;

FIG. 8 shows example point-source and near-point-source target/sensor modeling;

FIGS. 9A-9B-9C and 9D show summaries of a Closely-Spaced-Object (CSO) resolution algorithm developed for tracking multiple point-source targets in a high-density threat engagement;

FIG. 10 is a flowchart showing how the closely spaced object (CSO) resolution algorithm of FIG. 9 is generated; and

FIG. 11 shows a chart of CSO resolution performance across a variety of relative intensities of targets.

### DETAILED DESCRIPTION OF THE PREFERRED EMBODIMENTS

The embodiments herein overcome scattering of light that is caused by fog, thereby increasing visibility. The light is still scattered, but viewing fog through the embodiments herein can strip out some of the scattered light. What remains is a more exact illustration, where boundaries, shapes, and maybe even colors become more recognizable.

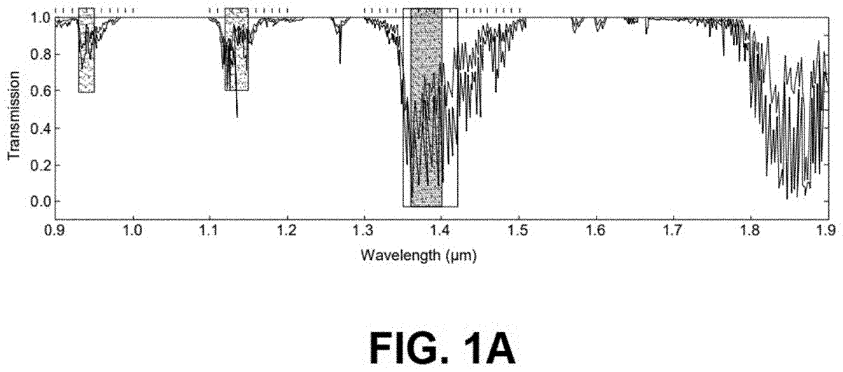

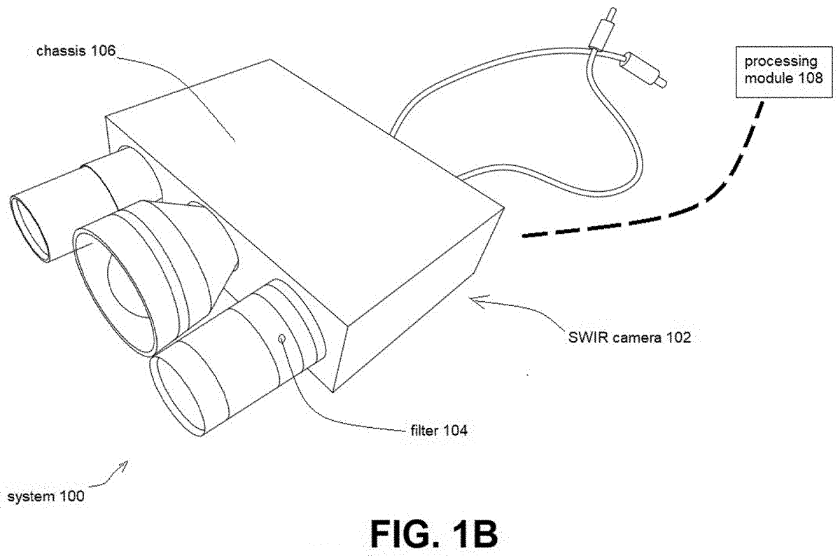

FIG. 1A shows a spectrograph of water absorption in the Near InfraRed/Short Wave InfraRed (NIR/SWIR) regions, including absorption bands in water at 940 nm, 1130 nm, 1390 nm and 1850 nm. When light within these wavelengths passes through water, such light is extinguished in a relatively short pathlength. It is possible to exploit this property of water to reduce an amount of scattered light through fog and reflected from clouds.

However, there exists a much deeper water absorption band in the SWIR spectral region (e.g. 1400 nm with a bandwidth of e.g. 70 nm). This SWIR spectral region also includes absorption bands for related phenomena such as oil fogs, sand/dust reflection, and CO2/H2O band ratios for reducing background clutter.

To take advantage of these conditions, FIG. 1B shows a system 100 having a filter 104 housed within a frame/chassis 106 of an SWIR sensor (camera) 102. The system 100 also comprises a processing module 108 which is external to the frame/chassis 106. The processing module 108 receives visual information from the SWIR camera 102 that has been altered by the filter 104, and performs various digital signal processing thereupon, and then displays this video information in potentially a variety of locations and computer screens.

An embodiment comprises the SWIR camera 102 being fitted with the filter 104 tuned to 1400 nm. Using the 1400 nm water absorption band, the system 100 collects and then using the processing module 108 produces high-end videos showing for example the fog penetration performance of the specialized SWIR camera compared to visible, NIR and unmodified SWIR passbands.

The processing module 108 can be implemented in a variety of configurations, including both software, firmware, customized hardware, and other ways of fabricating sophisticated electronic and digital signal processing components.

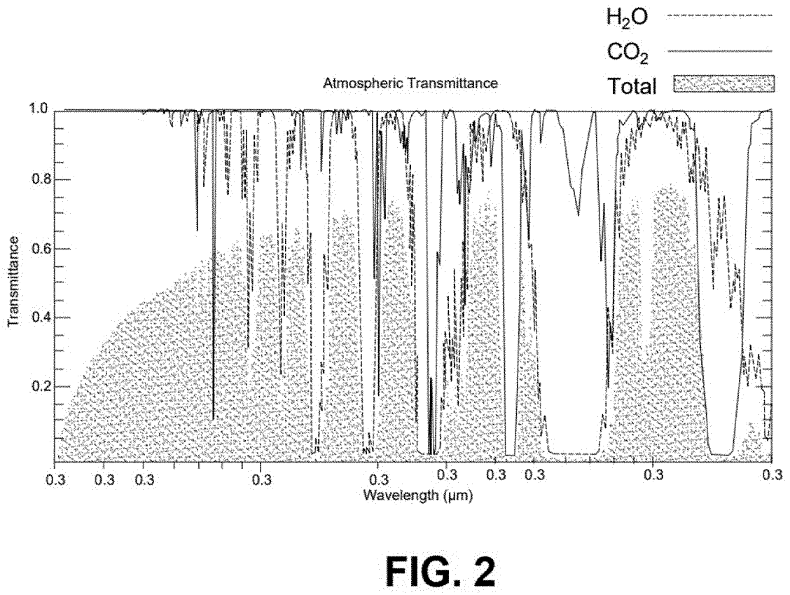

FIG. 2 shows changes in atmospheric transmittance according to variations in wavelength. The improved viewing capability provided by the system 100 can for example increase the fraction of the earth not totally blocked by cloud cover. In particular, there may be significant increase in viewable area around cloud edges. For exoatmospheric targets, ratios of the H2O and CO2 absorption bands can be exploited to increase signal to noise and reduce ground clutter. The system 100 can thus significantly improve detection and tracking performance of exoatmospheric targets, especially in combination with intelligent algorithms.

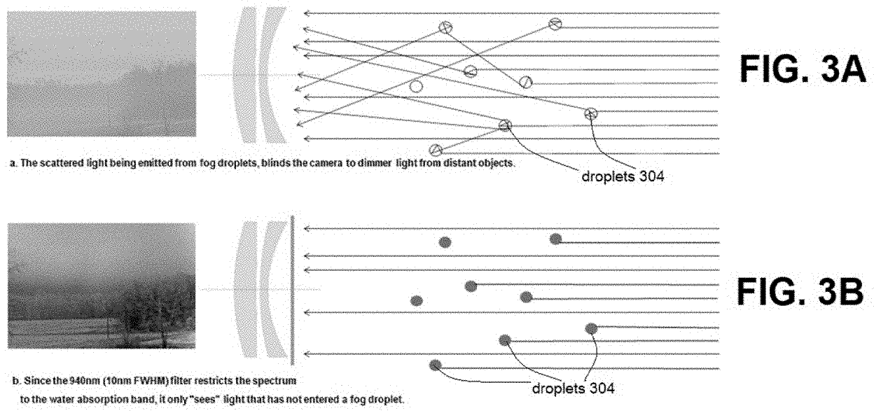

FIGS. 3A and 3B show a method by which scattered light is reduced in the water absorption band. Specifically, FIG. 3A shows that when light from a distant object enters a fog droplet it exits as scattered light. This scattered light does not contribute to forming an image of any object. Accordingly, sunlight and other light scattered from fog droplets can blind a sensor from detecting any dimmer distant objects. As shown in FIG. 3B, limiting the sensor's spectral range to an absorption band of water, such as is done by the system 100, essentially “turns off” the fog as a source of scattered light. This in turn greatly increases image clarity.

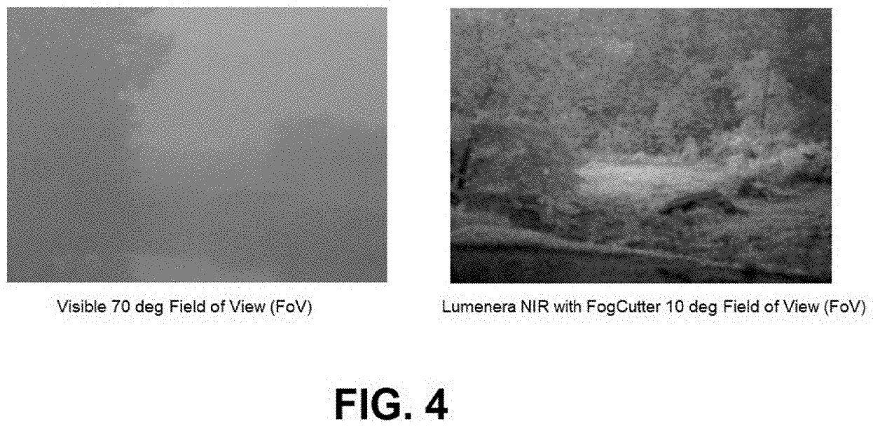

FIG. 4 shows a standard visible view (left) compared with a view (right) provided by an earlier version of the system 100 at 940 nm. Unfortunately, a usable passband at 940 nm is around 10 nm, which limits this band to full daylight applications. This means that the camera settings would need to be remotely selectable.

Meanwhile, in sharp contrast, the system 100 operates at 1400 nm (1.4 micron) which is in the high detectivity region of HgCdTe (Mercury Cadmium Tellerium) detector arrays used for detecting IR and focal planes. The depth of the water absorption band is much stronger at 1400 nm and SWIR naturally provides a better fog penetration than Visible/NearInfraRed (VIS/NIR). Further, the water absorption band is around 70 nm wide so the SWIR camera 102 within the system 100 can be operated with a much wider field-of-view and still take advantage of the improved fog viewing capability.

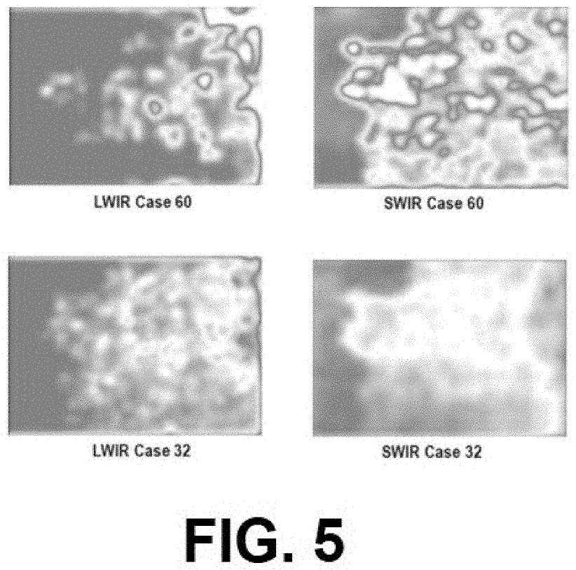

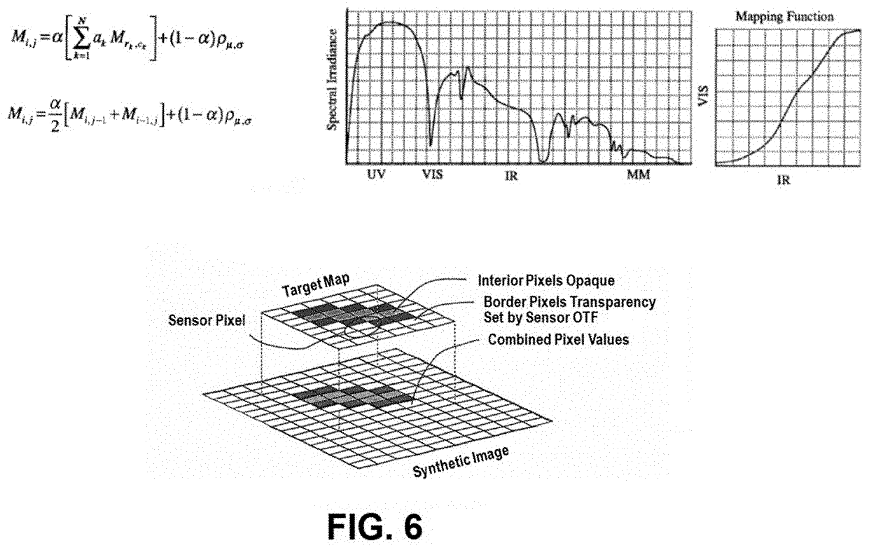

FIG. 5 shows empirical cloud modeling using U.S. Army Ground-Based Measurements (GBM) Sensor in the LWIR and SWIR passbands. Using the system 100, it is also possible to calibrate an autoregressive model to simulate cloud interiors with matching intensity characteristics. In doing so, a quasi-fractal model can be used to simulate the cloud boundaries. This quasi-fractal model is shown in FIG. 5 and the autoregressive mechanisms are shown in FIG. 6. Specifically, FIG. 6 shows autoregressive moving average modeling.

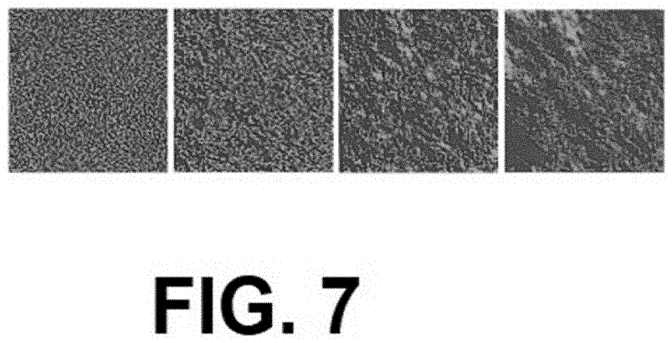

FIG. 7 shows a visual application of the framework of FIG. 6 to a particular cloud, in which alpha (a) is varied, and how variations of alpha (a) change the cloud imaging. Specifically, alpha (a) refers to a coefficient within something known as an ARMA polynomial, which sets the fraction of pixel to pixel change that is random rather than determined by the neighbor pixels. The expression “ARMA” not an acronym, but instead refers to a type of statistical processing method, in particular how to determine whether something is part of a signal or instead is mere noise. Thus, within this disclosure, when the expression “ARMA polynomial” is used, that likely relates to SNR issues.

Next, the embodiments herein contemplate either/any of software, or a toolkit, or a GUI which enables users to vary alpha (a), using perhaps a slider-bar mechanism. Further, an end-customer\purchaser of the system 100 might create his own alpha “slider bar” for consistency with their own preferred visual flow. Either way, the embodiments herein can achieve an end-user package where a customer can pick their own mechanism for representing and varying alpha (a). This in turn means the customer has options for “tuning” or adjusting alpha (a) and then visually observing which setting of alpha achieves the best visual image.

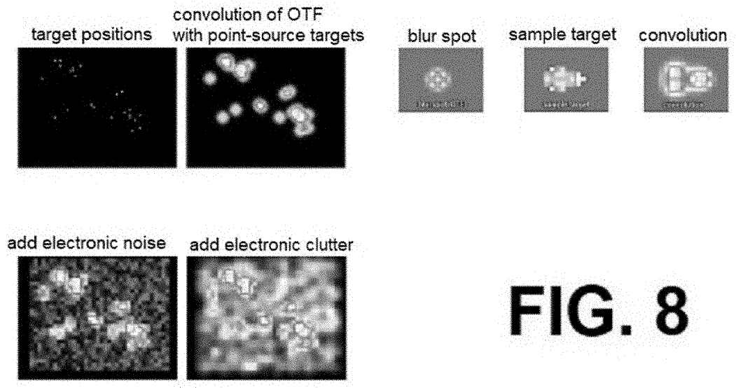

FIG. 8 shows example point-source and near-point-source target/sensor modeling, Specifically, FIG. 8 shows a medium fidelity model comprising: target positions; an optical transfer function of the sensor; effects of electronics noise; addition of external background clutter, and effects of SWIR on scattered light from clouds.

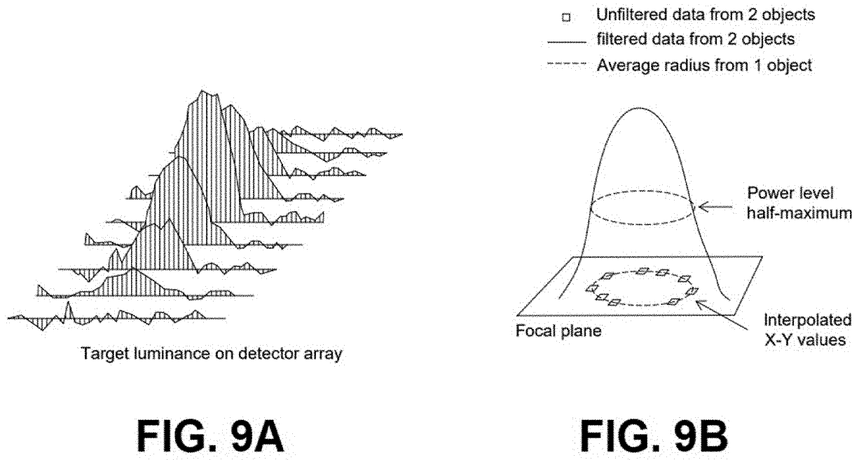

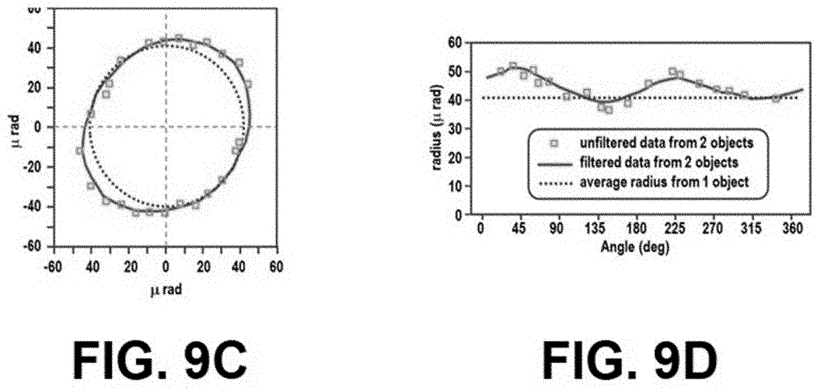

FIGS. 9A-9B-9C and 9D show a summary of a Closely-Spaced-Object (CSO) resolution algorithm developed for tracking multiple point-source targets in a high-density threat engagement.

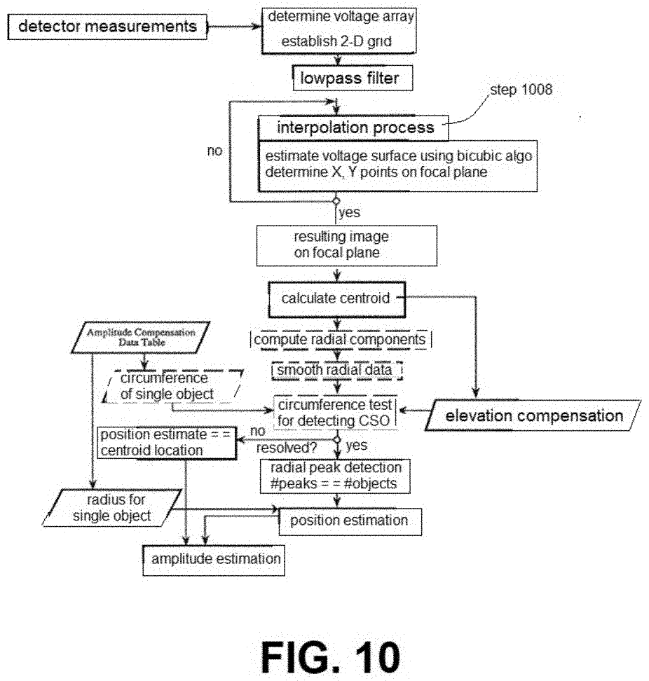

FIG. 10 is a flowchart showing how the closely spaced object (CSO) resolution algorithm of FIG. 9 is generated. Lowering a clutter level and achieving higher SNR can improve CSO resolution performance.

A point source object is when an object's image is just a blurry spot on a focal plane. Within FIG. 10, the various dashed boxes are the parts of the algorithm that would need to be modified for non point-source objects. A size and shape of the blurry spot can sometimes be a function of the optical system (i.e. modulation transfer function MTF). For larger objects, the shape of its image is a convolution of the sensor MTF and the shape of the object.

Within the interpolation step 1008 of FIG. 10, candidate object patterns are compared with actual measurement to see if the model matches the actual data closely enough. IF the answer is “yes”, that means the flow can move on to the next step. If “no”, it is necessary to make alterations to the candidate object patterns.

The process at the bottom of FIG. 10 checks to see if the image is a single object, or comprises multiple objects too close to count using separate peaks, in which case a radial variance mechanism is used to estimate an object count.

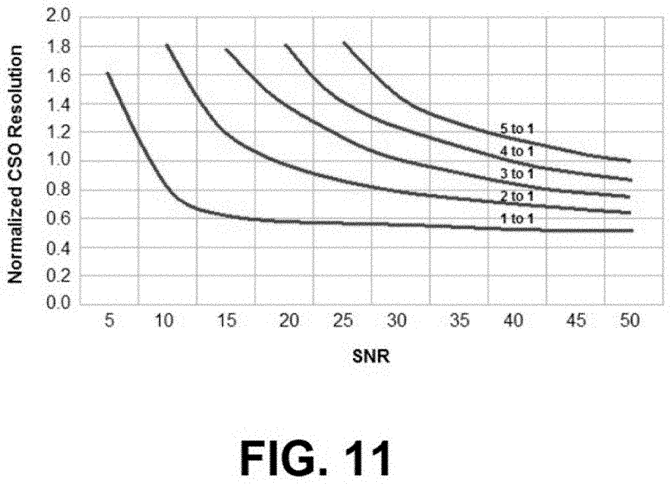

FIG. 11 shows a chart of CSO resolution performance across a variety of relative intensities of targets. Using FIG. 11 it should be apparent that limiting the SWIR camera 102 to a water absorption band can double the effective SNR. The performance of a CSO resolution algorithm is a function of the relative intensities of the two targets and the average SNR.

### Additional Embodiments

To the extent not already discussed herein, further embodiments are contemplated. These include, but are not limited to: oil fog obscurant penetration; penetration for brownout; multi-band effects including SNR enhancement and clutter reduction; and multi-frame image enhancement for stationary scenes.

### Potential Business Models

The 1400 nm spectral region is a niche area having numerous opportunities for commercial exploitation. Potential sales channels include but are not limited to transportation-related organizations which are tasked with monitoring for accidents in fog prone areas. This may include US Coast Guard for port monitoring, but also the Army Corp of Engineers for dam/lock monitoring.

Further embodiments include oil fog penetration, sand/dust penetration, water/carbon dioxide band ratio SNR enhancement, and background clutter reduction. Additionally, technologies exploiting optical properties of materials is the SWIR spectral region. Some components may include the processing module 108 being in the format of a tablet/laptop having customized software loaded therein.

There exist numerous ways of testing and affirming proper performance of the system 100. These can include an oil fog generator, various filters, and a field reflectance spectrometer. Such test kits for the system 100 can be shown to and/or loaned to potential customers, and be made part of the purchase. The oil-fog generator could be used for simulating/testing related to the system 100 can include testing on oil fogs and sand/dust (haboob) visibility.

Another embodiment of the system 100 features a candidate sensor for a weather tracking mesonet for a traffic corridor along a highway, e.g. an I-65 traffic corridor. This application uses both the filter (1400 nm) and various software components including but not limited to the processing module 108 for image enhancement. The improved imagery provided by the system 100 permits detection and identification of traffic accidents and obstacles on a highway in all weather conditions. These data-points could be embedded within traffic alerts found in e.g. Google Maps.

The system 100 can also be configured to provide upgrades to an Enhanced Regional Situation Awareness (ERSA) visual warning system. That embodiment of the system 100 could include a telephoto lens systems, i.e. narrow field-of-view lens suited to the multilayer bandpass filter since its passbands shifts with changing angle-of-incidence.

The system 100 also can be used to increase Signal to Noise Ratio (SNR) and reduce background clutter for e.g. satellite surveillance and tracking of hypersonic missiles. The Tranche 1 and Tranche 2 layers for detecting and tracking of hypersonic missiles is well matched to the 1400 nm and 2.8 micron water absorption bands. In addition, a CO2 absorption band adjacent to the H2O absorption band can be exploited to enhance SNR and reduce clutter/noise viewing against the hard earth background. In this embodiment, a 2.8 micron absorption band for water is used, and narrower still is a co CO2 absorption band. In the narrower bandit becomes possible to penetrate the cloud by turning the fog off. It is also possible to simplify background clutter by assessing CO2 as a curtain to eliminate anything coming up from the ground. Doing so reduces more background than the sought-after target being viewed, thus increasing SNR.

As a way of testing/verifying the system 100 in such a hypersonic missile scenario, it is possible to view a target looking in and out of the spectral band mentioned earlier. To determine when missiles are going into the atmosphere, a viewer can hop back and forth between the two bands, and thereby obtain an estimate of the altitude of that object as it's burning in. The deeper a missile goes, the more CO2 will be blocked going down, dropping altitude, thus detecting something as it's burning In reentry.

### Disclaimer

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A method of improving visibility within a fog-laden environment, comprising:
arranging a Short Wave InfraRed (SWIR) camera to have a plurality of lenses, a customized filter, and a processing module;
attaching the customized filter to one of the plurality of lenses of the SWIR camera thereby achieving a spectral range matching with an absorption band of water;
configuring another lens of the SWIR camera to be unaltered by any filters;
providing a processing module for operating and communicating with the SWIR camera; thereby
capturing a first video signal which has turned off the fog as a source of scattered light;
capturing a second video signal which retains the fog as a source of scattered light; and
the processing module transmitting a real-time version of the first and second video signals to a computer screen that is visible to human eyesight.

2. The method of claim 1, further comprising:
locating the customized filter within the chassis of the SWIR camera; and
locating the processing module outside of the chassis of the SWIR camera.

3. The method of claim 2, further comprising:
calibrating the customized filter to stay as close as possible to a base band of 1400 nm.

4. The method of claim 3, further comprising:
the processing module configuring the SWIR camera to have a window of 35 nm either side of the base band, thus achieving a window having a width of 70 nm.

5. The method of claim 1, further comprising:
configuring the customized filter and the processing module for oil fogs and sand/dust visibility, instead of fog.

6. The method of claim 4, further comprising:
configuring the processing module for facilitating a user varying an alpha which is a fraction of pixel to pixel change that is random rather than determined by the neighbor pixels.

7. The method of claim 6, further comprising:
providing a slider-bar GUI such that a user can vary alpha.

8. The method of claim 6, further comprising:
providing a toolkit such that an end-customer can create his own slider bar fa varying alpha.

9. The method of claim 4, further comprising:
providing upgrades to an Enhanced Regional Situation Awareness (ERSA) visual warning system using a telephoto lens systems having narrow field-of-view and a multilayer bandpass filter; and
configuring the processing module for shifting one or more passbands as angle-of-incidence changes.

10. The method of claim 4, further comprising:
utilizing empirical cloud modeling by collecting authentic cloud data in Long Wave InfraRed (LWIR) and SWIR passbands;
calibrating an autoregressive model to simulate cloud interiors with matching intensity characteristics; and
using a quasi-fractal model to simulate the cloud boundaries.

11. The method of claim 10, further comprising:
utilizing autoregressive moving average modeling.

12. The method of claim 4, further comprising:
tracking multiple point-source targets in a high-density threat engagement utilizing a Closely-Spaced-Object (CSO) resolution algorithm.

13. The method of claim 12, further comprising:
utilizing point-source and near-point-source target/sensor modeling.

14. The method of claim 13, further comprising:
configuring the SWIR camera with a second filter matching with CO2 absorption band.

15. The method of claim 14, further comprising:
exploiting a CO2 absorption band adjacent to the H2O absorption band that can be exploited to enhance SNR and reduce clutter/noise while viewing against the Earth's surface as a background.
